(19) United States
(12) Patent Application Publication
(10) Pub. No.: US 2014/0317858 A1
(43) Pub. Date: Oct. 30, 2014

(54) DETERGENT GRANULES WITH A WATER-SWELLABLE COMPONENT

(71) Applicant: The Procter & Gamble Company, Cincinnati, OH (US)

(72) Inventors: Hong Sing TAN, Ceijing (CN); Jianze MA, Beijing (CN)

(73) Assignee: The Procter & Gamble Company, Cincinnati, OH (US)

(21) Appl. No.: 14/220,173

(22) Filed: Mar. 20, 2014

(30) Foreign Application Priority Data
Apr. 26, 2013 (WO) CN2013/074829

(51) Int. Cl. C11D 17/06

(52) U.S. Cl. CPC C11D 17/065
USPC 8/137; 510/446

(57) ABSTRACT

The present invention relates to a detergent granule comprising a water-swellable component (e.g., CMC), neutralizing agent (e.g., Na₂CO₃) and anionic surfactant, as well as a process for making same. Granular detergent compositions comprising the detergent granules and methods of using thereof are also encompassed.

### FIELD OF THE INVENTION

The present invention relates to an agglomerated detergent granule comprising: a water-swellable component, (e.g., carboxy methyl cellulose (CMC); a neutralizing agent, (e.g., sodium carbonate); and an anionic surfactant, and process of making same. The present invention also encompasses a granular detergent composition comprising the detergent granules, and methods of using thereof.

### BACKGROUND OF THE INVENTION

In today's laundry detergent markets, consumers, particularly those who hand-wash, demand products with fast dissolution profiles and desirable hand feel sensorial properties during washing. Typically, detergent manufacturers have used agglomeration process to produce higher bulk density detergent granules that are more compacted and have lower porosity than typical powder detergents made via spray drying process. These agglomerated granules may have slower dissolution profile, and result in consumer noticeable hardness and/or gritty/abrasive hand feel under typical hand-washing conditions. In one aspect, agglomerated granules comprising sodium carbonate may first convert to a hydrated form, e.g., sodium carbonate decahydrate. Without being bound by theory, it is believed that the harsh hand feel of the agglomerated granules may come from the slow-to-dissolve carbonate decahydrate. Therefore, there remains a need for detergent granules having the desired hand feel sensorial properties to delight consumers and a process to produce them. It is also desirable that the detergent granules can deliver cleaning performance that is, at least, comparable with conventional spray-dried granules.

Water-swellable materials such as, for example, carboxy methyl cellulose (CMC), are known to function as disintegrants for making detergent tablets to improve dissolution. It has now been surprisingly discovered that the addition of CMC into the detergent granules can also have a positive impact on reducing hardness and/or abrasive/gritty hand feel of the granules. Typically, an agglomeration process that incorporates CMC would also include a pre-neutralized surfactant such as Linear AlkylBenzene Sulfonate (LAS) (see PCT Publication WO00/37598). It has now been found that the use of in situ dry neutralization, instead of a pre-neutralized paste, in combination with the agglomeration process, and at particular ratios of neutralizing agent to water-swellable component, allows for the optimization of the water-swellable component's functionality in the detergent granules to deliver the desirable sensorial hand feel properties during hand-washing.

### SUMMARY OF THE INVENTION

The present invention relates to a detergent granule comprising, by weight of the detergent granule, (i) from about 10 wt % to about 30 wt % of at least one anionic surfactant, (ii) from about 1 wt % to about 10 wt % water-swellable component, wherein the component is a cellulosic material that rapidly swells after contact with water, and (iii) from about 50 wt % to about 65 wt % of a neutralizing agent, preferably carbonate, wherein the ratio of the neutralizing agent to the water-swellable component is from about 5:1 to about 30:1. This ratio is critical for providing the necessary alkalinity buffer against the acid precursor to protect the CMC from degradation. In one embodiment, the anionic surfactant is obtained via a dry neutralization and agglomeration process. The present invention also encompasses a process for making the detergent granules, granular detergent compositions comprising the detergent granules and methods of use thereof.

### BRIEF DESCRIPTION OF THE DRAWINGS

While the specification concludes with claims particularly pointing out and distinctly claiming the invention, it is believed that the invention will be better understood from the following description of the accompanying figures wherein:

FIGS. 1A & 1B provides photos of embodiments of the detergent granules of the present invention with or without 10 wt % CMC.

FIG. 2 provides the graph for the Saturation Capacity of the HLAS:Weight Powder Ratio.

FIG. 3 provides a diagram of the beaker in use for the Hardness Test Method.

FIG. 4 provides a graph of the Granule Compaction Force of the detergent granules from Example 2.

### DETAILED DESCRIPTION OF THE INVENTION

As used herein, articles such as “a” and “an” when used in a claim, are understood to mean one or more of what is claimed or described.

As used herein, the terms “include”, “includes” and “including” are meant to be non-limiting.

As used herein, “granular detergent compositions” includes a solid composition such as granular or powder-form all-purpose or heavy-duty washing agents for fabric, as well as cleaning auxiliaries such as bleach, rinse aids, additives, or pre-treat types.

As used herein, the term “water-swellable component” or “water-swellable material” refers to a cellulosic material that is incorporated into the detergent granules and can rapidly swell after contact with water to form a cocoon around the detergent granule to improve its hand feel properties.

As used herein, the term “Particle Size” refers to the equivalent size of a standard sieve through which the particle can pass, as determined by the Median Particle Size Test described herein.

As used herein, the term “Median Particle Size” refers to the mid-point of the distribution of the particle sizes of the detergent granule, as measured by the Sieve Test as disclosed herein. “Median Particle Size” also refers to the mid-point of the distribution of the particle sizes of the fine powders, as measured by the Laser Diffraction Test as disclosed herein.

As used herein, the term “Saturation Capacity” means the ratio of an absorbed liquid relative to the mass of the particle (e.g., carbonate), as measured by the Saturation Capacity Test as described herein.

As used herein, the term “Granule Compaction Force” means the amount of force measured in Newtons (N) required to compact a detergent granule from 1.00 mm to 0.20 mm as measured by the Hardness Test Method described herein.

As used herein, the term “substantially free” means that no amount of that component is deliberately incorporated into the composition.

It is understood that the test methods that are disclosed in the Test Methods Section of the present application must be used to determine the respective values of the parameters of Applicants' inventions as described and claimed herein.

In all embodiments of the present invention, all percentages are by weight of the detergent granule or granular detergent composition, as evident by the context, unless specifically stated otherwise. All ratios are weight ratios, unless specifically stated otherwise.

### Detergent Granules

The present invention is directed to a detergent granule comprising, by weight of the detergent granule:
a) from about 10 wt % to about 30 wt %, preferably from about 20 wt % to about 28 wt %, and more preferably from about 22 wt % to about 26 wt % of at least one anionic surfactant;
b) from about 1 wt % to about 10 wt %, preferably from about 2 wt % to about 8 wt %, and more preferably from about 2.5 wt % to about 6 wt % water-swellable component; and
c) from about 30 wt % to about 80 wt %, preferably from about 40 wt % to about 70 wt %, and more preferably from about 50 wt % to about 65 wt % neutralizing agent.

wherein the water-swellable component is a cellulosic material that rapidly swells up within 10 minutes, preferably within preferably within 5 minutes, more preferably within 2 minutes, even more preferably within 1 minute, and most preferably within 10 seconds, after contact with water, and wherein the ratio of the neutralizing agent to water-swelling component is from about 5:1 to about 30:1, preferably from about 10:1 to about 20:1. In one embodiment, it is the ratio of the carbonate to the CMC that is important for the present invention.

One of the chemical constraints to the reaction process is that the detergent formulation be substantially HLAS free, as it could degrade CMC upon contact. Further, acidic conditions are bad for other ingredients in the detergent composition such as, for example, perfumes, enzymes, and polymers. Of this embodiment, the ratio of the neutralizing agent to CMC is limited by the alkalinity buffer provided by the carbonate to protect CMC degradation from direct contact with the acid precursor of the anionic surfactant.

In another embodiment, the anionic surfactant in the detergent granule is obtained by dry neutralization and agglomeration process, wherein the dry neutralization reaction involves the chemical neutralization of an acid precursor of an anionic surfactant added to a mixture of neutralizing agent and water-swellable component, wherein the acid precursor will be neutralized to form the anionic surfactant with the water-swellable component, preferably CMC. In one aspect, the neutralizing agent should be present in a stoichiometric excess over the acid precursor of the anionic surfactant. In another aspect, the dry neutralization occurs simultaneously with the agglomeration process, which involves mixing the ingredients listed above in a mixer.

Typically, CMC has been incorporated into detergent compositions as a disintegrant to aid in dissolution. In the present invention, it was surprisingly discovered that the addition of CMC to detergent granules can improve the sensorial hand feel experience to consumers that hand-wash fabrics. Preferably, the CMC-containing detergent granules will work over a variety of hand-washing methods such as, for example, hand-washing only, and hand-washing combined with semi-automatic washing machines. It is also desirable that the detergent granules, which include anionic surfactants, can be operable under varying hand-washing conditions, such as, for example, high water hardness, and cold water temperature, which are known to be problematic for anionic surfactants.

It has been discovered that the addition of CMC into the detergent granules will lessen the hardness and/or gritty/abrasive hand feel of the detergent granules. Without wishing to be bound by theory, it is believed that the hand feel benefit may be driven by the swelling of the CMC upon contact with water to create a softening texture on the surface of the detergent granules thereby causing the detergent granules to have a less gritty/abrasive hand feel to the touch.

In one aspect, the water-swellable component includes a cellulosic material that rapidly swells up within 10 minutes, preferably within 5 minutes, more preferably within 2 minutes, even more preferably within 1 minute, and most preferably within 10 seconds, after contact with water. It is believed that this effect is fast and easily noticeable by the consumers upon the initial use such as, for example, dispersion of the powder in the hand wash basin. Further, it has been discovered that this surprising benefit can be maintained for a substantial portion of or all of the wash/rinse cycles, regardless of the order of addition of the materials (e.g., cellulosic material, neutralizing agent and acid precursor).

In another aspect, the cellulosic material is water soluble so as to minimize any residue deposition in the wash liquor or on the fabrics. Suitable examples of cellulosic material are selected from the group consisting of optionally substituted alkyl celluloses and salts thereof, such as ethylcellulose, hydroxyethyl cellulose, hydroxypropyl methyl cellulose, methyl cellulose, carboxy methyl cellulose (CMC), and mixtures thereof. Other suitable water-swellable material may include cross-linked CMC (see US2006/0019860), modified CMC (see WO2000/37598) , and mixtures thereof. Preferred examples of the cellulosic material include CMC, cross-linked CMC, modified CMC, and mixtures thereof. CMC is a particularly preferred water-swellable component, especially those CMC having 55% or 70% activity. The 55% active CMC is more preferred because based on the per unit parts of CMC in the finished granular detergent composition, more of the 55% active CMC would have to be added, as compared to the 70% active CMC. By including a higher amount of the 55% active CMC, it should improve the dispersion of the CMC throughout the finished granule to ensure uniform swelling. Preferably, the CMC does not prematurely swell. To avoid this from happening it may be useful to limit the amount of water that is present during the reaction process to make the detergent granules. In one embodiment, the dry neutralization and agglomeration process is substantially free of water and having, preferably by weight of the detergent granule, between about 0 wt % and about 3 wt %, preferably between about 0.1 wt % and about 1 wt %, and more preferably between about 0.2 wt % and about 0.5 wt %, of water. If there is any water present, preferably the water can be present in the HLAS and not in neutralizing agent. The amount of water is calculated based on the total water added to the reaction process and the water that may be present inherently in the materials being added to the reaction process. In another embodiment, the detergent granule is substantially moisture free.

The challenge of working with CMC is that it can completely decompose chemically in an acid medium. Therefore, it is difficult to make agglomerated detergent composition directly from starting detergent ingredients that includes acid precursor of surfactant, and with CMC as part of powder substrate. To overcome this problem, the inventors have surprisingly found that the use of dry neutralization and agglomeration process, particularly simultaneously, can maintain the functionality of the CMC due to the high alkalinity of the resulting mixture. The high alkalinity may be derived from the neutralizing agent used for the dry neutralization process.

In one embodiment, the neutralizing agent is a carbonate salt selected from the group consisting of a normal light carbonate salt, a ground light carbonate salt, and mixtures thereof, wherein the mixtures having a ratio from about 1:4 to about 1:10 of normal light carbonate salt to ground light carbonate salt. The mixture of normal light carbonate salt and ground light carbonate salt is often designed to maintain process robustness in targeting mean particle size and fresh granule flow ability through optimal ratio. The carbonate salts have a Median Particle Size (D50) of between about 50 μm and about 250 μm for the normal light carbonate salt; and between about 10 μm and about 30 μm for the ground light carbonate salt. The D₅₀ is determined by the Median Particle Size Test Method as described herein using the Laser Diffraction Method.

In yet another embodiment, the neutralizing agent is a ground dense carbonate salt having a Saturation Capacity of 0.20 to about 0.33 as determined by the Saturation Capacity Test Method. While ground light carbonate is generally preferred based on its higher saturation capacity, ground dense carbonate salt may be utilized due to price increases for the normal light carbonate salt, and ground light carbonate salt or scarcity of those materials.

In another embodiment, the carbonate salt is selected from the group consisting of sodium carbonate, sodium bicarbonate and mixtures thereof.

Useful anionic surfactant acids include dry neutralization reaction products having in their molecular structure an alkyl group containing from about 9 to about 20 carbon atoms. Examples include the alkyl benzene sulfonates in which the alkyl group contains from about 9 to about 15 carbon atoms in straight chain configuration. Especially suitable anionic surfactant acids are linear alkyl benzene sulfonates (LAS) in which the alkyl group contains from about 11 to about 13 carbon atoms.

In yet another embodiment, the detergent granule may optionally comprise from about 1 wt % to about 40 wt %, preferably from about 5 wt % to about 35 wt %, and more preferably from about 10 wt % to about 30 wt % sulfate, and wherein the ratio of the ground light carbonate salt to the sulfate is from about 1:0.5 to about 1:2. Such mixture may be designed to improve flowability of the fresh granule, and/or to reduce the risk of sulfate segregation when added via admixing.

In one embodiment, the detergent granules of the present invention exist in the form of agglomerate. In an aspect, the agglomerate may have a Median Particle Size between about 100 μm and about 600 μm, preferably between about 200 μm and about 500 μm, and more preferably between about 300 μm and about 400 μm, as determined by the Median Particle Size Method as described herein.

The detergent granules of the present invention have desirable sensorial hand feel properties. One way to assess whether the detergent granules have the required hand feel property is to measure the hardness of the detergent granules, which correlates to the normal force required to deform the particles from a height of 1.0 mm to 0.2 mm after soaking in water for 20 seconds. The height of 1.0 mm serves as the starting point because at this height the air and liquid content of the granules have already been squeezed out. Any more force required to compress the granules is then contributed mainly by its hardness.

According to the Hardness Test Method as described herein, the detergent granule has a Granule Compaction Force of from about 0.01 Newton (N) to about 0.4 N, preferably from about 0.1 N to about 0.3 N, and more preferably from about 0.15 N to about 0.25 N. Therefore, the detergent granules of the invention that have desirable sensorial hand feel properties would have Granule Compaction Force in the above recited range, as confirmed by consumer testing. The detergent granules which do not have the desired sensorial hand feel properties would have a Granule Compaction Force greater than 1N, preferably greater than 0.75 N and more preferably greater than 0.5 N, as determined by the Hardness Test Method as described herein.

### Process for Making Detergent Granules

The process for preparing the detergent granules according to the invention comprises the following steps:
(a) mixing raw materials into a mixer, wherein the raw materials comprises of:
   (i) from about 1 wt % to about 10 wt % of water-swellable component;
   (ii) from about 10 wt % to about 30 wt % of an acid precursor of an anionic surfactant selected from the group consisting of alkylbenzene sulfonic acid, alkyl sulfuric acid, and mixtures thereof;
   (iii) from about 30 wt % to about 70 wt % neutralizing agent;
   (iv) from about 0.4 wt % to about 3 wt % water (including water in the other raw materials); and
   (v) optionally from about 1 wt % to about 40 wt % of sulfate.
   wherein the water-swellable component is a cellulosic material that rapidly swells up within 10 minutes, preferably within 5 minutes, more preferably within 2 minutes, even more preferably within 1 minute, and most preferably within 10 seconds, after contact with water, and wherein the weight ratio of neutralizing agent to water-swellable component is about 5:1 to about 20:1, preferably from about 10:1 to about 20:1;

(b) dry-neutralizing the acid precursor of the anionic surfactant with the neutralizing agent to produce an anionic surfactant; and

(c) agglomerating the raw materials from step (a) in a mixer to produce an agglomerate.

In one aspect, the useful acid precursor is selected from the group consisting of alkylbenzene sulfonic acid (HLAS), alkyl sulfuric acid, and mixtures thereof. Of this aspect, the anionic surfactant is LAS.

In an embodiment, the pH of mixture in the process is at least 7.0 or greater, preferably 8.0 or greater, and more preferably 9.0 or greater. The high alkalinity may be derived from the neutralization agent and can help to prevent the degradation of the CMC.

In another embodiment, the process can be carried out continuously, semi-continuously or batch-wise in a mixer. Suitable mixers may include, for example, a dual-axis counter rotating paddle mixer or continuous mid to high speed rotating mixer.

### Granular Detergent Compositions

In one aspect, the detergent granules can be a fully formulated detergent product. In another aspect, the detergent granules may be combined with other particles to form a fully formulated detergent product, such as a fully formulated laundry detergent product.

In one aspect, the detergent granules are typically added to the granular detergent compositions at a level of from about 5 wt %, 10 wt %, 15 wt %, 25 wt % to about 35 wt %, by weight of the detergent composition. In another aspect, the detergent granules can be present in granular detergent compositions in the range of from about 5 wt % to about 50 wt %, more preferably from about 10 wt % to about 40 wt %, and most preferably from about 15 wt % to about 30 wt %, by weight of the granular detergent compositions. Preferably, the granular detergent compositions of the invention have comparable or superior cleaning performance that is, at least, comparable with those made from conventional spray-dried granules having a similar derived formulation.

In one aspect, the detergent granules may be combined with other particles such as, for example: enzyme particles; perfume particles including agglomerates or extrudates of perfume microcapsules, and perfume encapsulates such as starch encapsulated perfume accord particles; surfactant particles, such as non-ionic detersive surfactant particles including agglomerates or extrudates, anionic detersive surfactant particles including agglomerates and extrudates, and cationic detersive surfactant particles including agglomerates and extrudates; polymer particles including soil release polymer particles, cellulosic polymer particles; buffer particles including carbonate salt and/or silicate salt particles, preferably a particle comprising carbonate salt and silicate salt such as a sodium carbonate and sodium silicate co-particle, and particles and sodium bicarbonate; other spray-dried particles; fluorescent whitening particles; aesthetic particles such as coloured noodles or needles or lamellae particles; bleaching particles such as percarbonate particles, especially coated percarbonate particles, including carbonate and/or sulphate coated percarbonate, silicate coated percarbonate, borosilicate coated percarbonate, sodium perborate coated percarbonate; bleach catalyst particles, such as transition metal catalyst bleach particles, and imine bleach boosting particles; performed peracid particles; hueing dye particles; and any mixture thereof.

It may also be especially preferred for the laundry detergent powder to comprise low levels, or even be substantially free, of builder. In a preferred embodiment, the laundry detergent comprises no builder.

In one aspect, a method of laundering clothes using the granular detergent compositions of the present invention is disclosed. Preferably, the granular detergent compositions herein are especially well-suited for use in a hand-washing context. It is preferable that the detergent compositions can be used in hard water conditions where the water hardness is between about 17 ppm to about 600 ppm; or from about 34 ppm to about 340 ppm; or from about 51 ppm to about 300 ppm of hard water ions such as Ca²⁺, Mg⁺, etc., or such as Ca²⁺ and Mg²⁺. It is also preferable that the detergent compositions can be used in cold water temperature, where the temperature is from about 5° C. to about 40° C., or from about 20° C. to about 30° C., or from about 15° C. to about 25° C., as well as all other combinations within the range of about 15° C. to about 35° C., and all ranges within 10° C. to 40° C.

### Method of Improving Sensorial Hand Feel Properties

In another aspect, the method of reducing abrasiveness or grittiness hand feel of a granular detergent composition of the present invention for hand-washing fabrics is disclosed. In this aspect, the method may comprise the step of adding a granular detergent composition of the present invention in a wash liquor and hand-washing the fabrics.

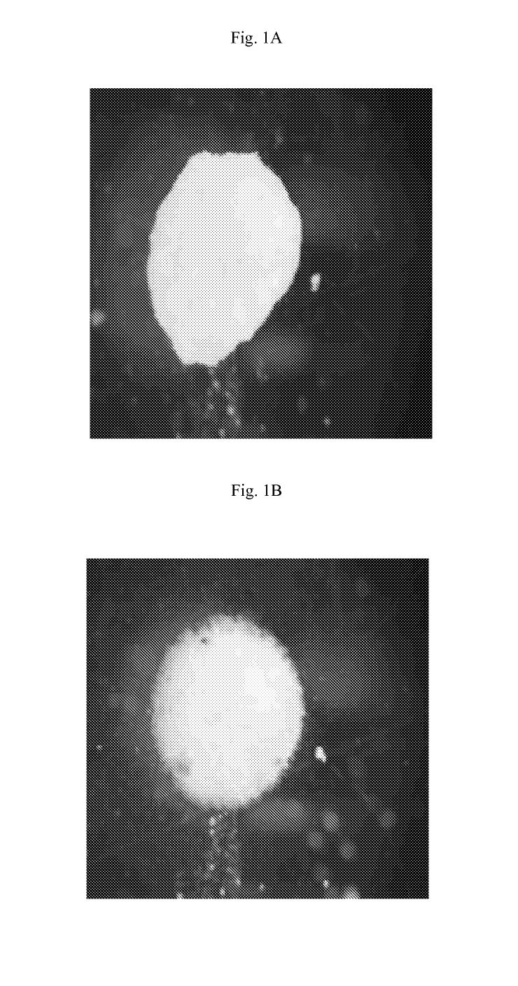

The CMC present in the granular detergent composition will rapidly swell after contact with water and envelopes the detergent granule in a cocoon that functions to reduce the abrasiveness of the texture of the agglomerate, thereby improving its hand feel properties. See FIG. 1 for a visualization of the cocooning effect of the CMC on the detergent granules versus a control detergent granule without CMC. It is this cocooning effect that is believed to reduce the grittiness of the detergent granules.

### Test Methods

The following techniques must be used to determine the properties of the detergent granules and detergent compositions of the invention in order that the invention described and claimed herein may be fully understood.

### TEST 1: Median Particle Size Test Method

a) Sieve Test Method

This test method must be used to determine the Median Particle Size of the agglomerated detergent granule's of the present invention. The particle size distribution of the detergent granules and granular detergent compositions are measured by sieving the granules through a succession of sieves with gradually smaller dimensions. The weight of material retained on each sieve is then used to calculate a particle size distribution and Median Particle Size.

This test is conducted to determine the Median Particle Size of the subject particle using ASTM D 502-89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E 11) sieves #8 (2360 μm), #12 (1700 μm), #16 (1180 μm), #20 (850 μm), #30 (600 μm), #40 (425 μm), #50 (300 μm), #70 (212 μm), and #100 (150 μm) is required. The prescribed Machine-Sieving Method is used with the above sieve nest. The detergent granule of interest is used as the sample. A suitable sieve-shaking machine can be obtained from W.S. Tyler Company of Mentor, Ohio, U.S.A. The data are plotted on a semi-log plot with the micron size opening of each sieve plotted against the logarithmic abscissa and the cumulative mass percent (Q3) plotted against the linear ordinate.

An example of the above data representation is given in ISO 9276-1:1998, “Representation of results of particle size analysis—Part 1: Graphical Representation”, Figure A.4. The Median Particle Size (D₅₀) is defined as the abscissa value at the point where the cumulative mass percent is equal to 50 percent, and is calculated by a straight line interpolation between the data points directly above (a50) and below (b50) the 50% value using the following equation:

D₅₀=10 [Log(Dₐ₅₀)−(Log(Dₐ₅₀)−Log(D_{b5o}))*(Qₐ₅ₒ−50%)/(Qₐ₅₀−Q_{bso})]

where Qₐ₅₀ and Q_{b50} are the cumulative mass percentile values of the data immediately above and below the 50^{th} percentile, respectively; and Dₐ₅₀ and D_{b50} are the micron sieve size values corresponding to these data. In the event that the 50^{th} percentile value falls below the finest sieve size (150 μm) or above the coarsest sieve size (2360 μm), then additional sieves must be added to the nest following a geometric progression of not greater than 1.5, until the median falls between two measured sieve sizes.

b) Laser Diffraction Method

This test method must be used to determine a fine powder's (e.g. raw materials like carbonate) Median Particle Size. The fine powder's Median Particle Size is determined in accordance with ISO 8130-13, “Coating powders—Part 13: Particle size analysis by laser diffraction.” A suitable laser diffraction particle size analyzer with a dry-powder feeder can be obtained from Horiba Instruments Incorporated of Irvine, Calif., U.S.A.; Malvern Instruments Ltd of Worcestershire, UK; Sympatec GmbH of Clausthal-Zellerfeld, Germany; and Beckman-Coulter Incorporated of Fullerton, Calif., U.S.A.

The results are expressed in accordance with ISO 9276-1:1998, “Representation of results of particle size analysis—Part 1: Graphical Representation”, Figure A.4, “Cumulative distribution Q3 plotted on graph paper with a logarithmic abscissa.” The Median Particle Size is defined as the abscissa value at the point where the cumulative distribution (Q3) is equal to 50 percent.

### TEST 2: Saturation Capacity Test Method

This test method must be used to determine detergent ingredient's (e.g., carbonate) Saturation Capacity. Saturation Capacity is the measure of a certain material's ability to absorb liquid. It can be highly dependent on the substrate and the liquid that needs to be absorbed. A well known method in the industry, DIN 53601, is through the use of a torque rheometer and DBP (Dibutyl Phtalate). This method records the evolution of the measured torque as the liquid is added at a controlled rate. A typical torque profile will have a slight increase initially over time followed by a sharp peak then a drop. The method is modified so that it is relevant for measuring the Saturation Capacity to the particular application of the present invention.

The steps for this method are described below:
1. Weigh approximately 20 g of the powder to be tested (where powder bulk density is approximately in the range of 100 to 300 gpl) in the small Kenwood food mixer (Mini Chopper/Mill CH180A). The powder weight could be adjusted depending on its bulk density to have similar fill level. Dodecyl-benzenesulfonic acid (96.5% active; HLAS) is weighed out in a syringe. HLAS is readily available from a number of commercial suppliers. A hole can be drilled on top of the mixer in location where the blades can chop the paste as it is being added.
2. Turn on the mixer and allow the powder to be mixed for 2 seconds prior to adding the HLAS. The paste is then added using the syringe at approximately 120 g/min The mixer is continued for approximately 1 second after all the pasted has been added. The resulting agglomerate is then sieved through a 1.4 mm metal sieve for 1 minute. Oversized material retained on the screen and the undersize material that passed through the screen are weighed separately. Amount of oversized is calculated by:

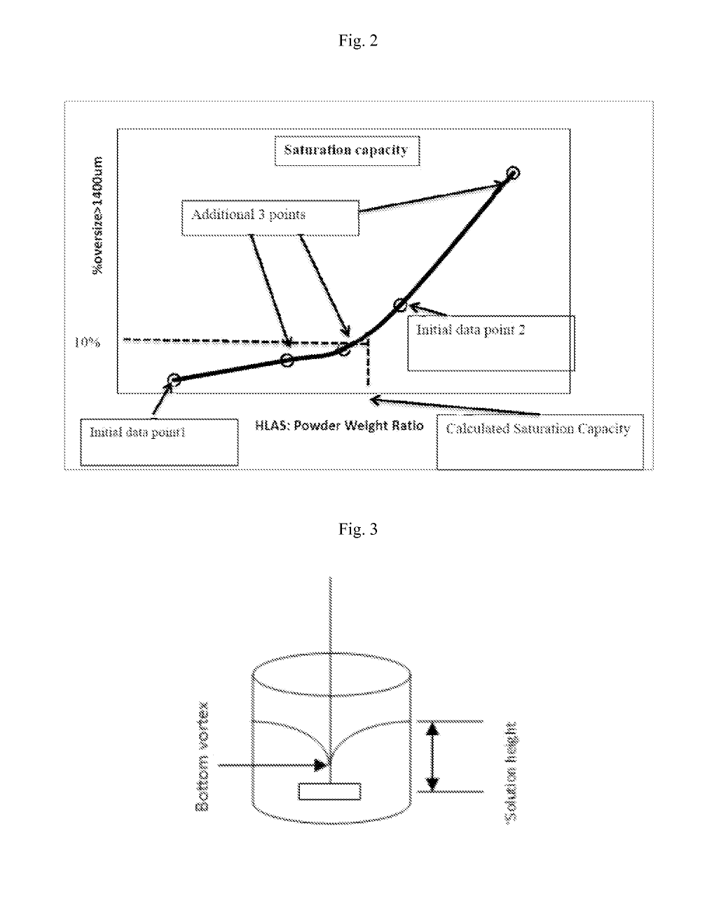

% oversized=weight of oversize/(weight of oversize+weight of undersize)×100
3. If the material's saturation capacity is totally unknown, a trial and error must be done to initially establish an indication as to where roughly the saturation point may lie. This is important to identify the spread of the 5 data point of HLAS: powder weight ratio later on as described above to quantify the saturation capacity. Weigh 2 different levels of HLAS in syringes. Each HLAS level is added to a new batch of pre-weighed powder as described above. A good example where one has acquired suitable estimate of the saturation capacity is when at least 1 point is below the saturation (<10% oversize) and the second data point is above saturation (>10% oversize).
4. Weigh 3 different amount of paste separately in addition to the first 2 data-points used for initial estimation with paste quantities calculated as HLAS: powder ratio predefined in such manner that ideally first 2 ratios will be below its saturation point, the third point close to its saturation point and the remaining 2 ratios are beyond its saturation point. Please refer to FIG. 2 for an example of steps 3 and 4.
5. Plot the 5 data points with % oversize on the Y-axis and HLAS :Powder weight ratio on the X-axis. Using a least square curve fit, calculate the intersection of 10% oversize and solve for the HLAS:Weight Powder Ratio.

### Test 3: Hard Test Method

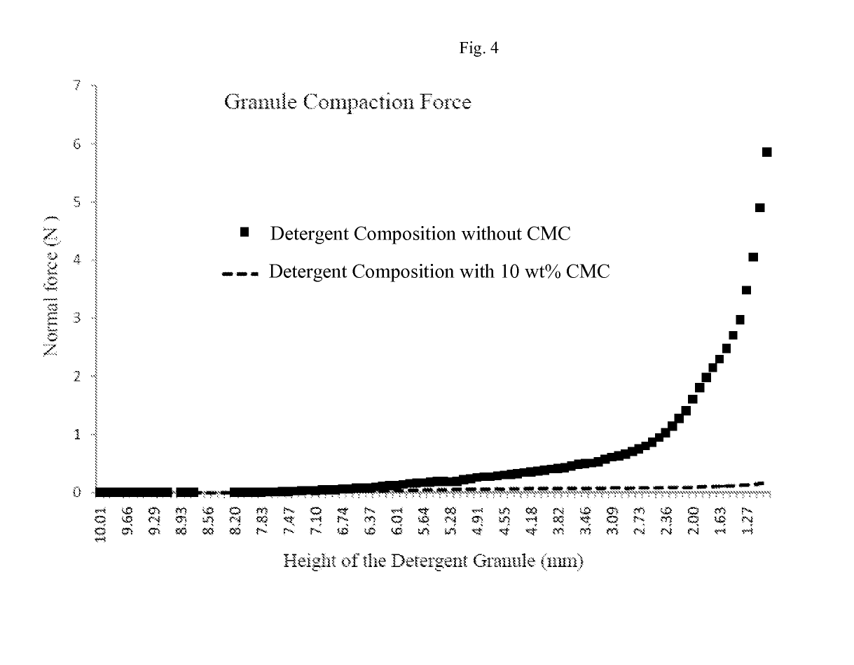

This test method must be used to determine the detergent granule's hardness, which can be correlated to the grittiness hand feel of those granules. The steps for this method are described below:
1. Place 2000 mL distilled water at 25° C.±2° C. into a 3000 mL beaker, then add 15 g of laundry detergent into the beaker. Laundry detergent granules made with and without the CMC are tested.
2. Place the beaker onto a magnetic plate and use a magnetic stir bar to mix the detergent solution for 20 seconds at room temperature. The bottom of the vortex should be in the middle of the middle of the solution height (see FIG. 3).
3. Filter the detergent solution using a 250 micron sieve and place the undissolved material onto the rheometer measurement plate. Place an 8 mm height ring onto the rheometer measurement plate and fill the undissolved material until the ring is full. Scrape the ring surface to remove excess undissolved material.
4. Use PP20 spindle and set the program to move from 10 mm to 2 mm within 60 seconds at rate of 0.11 mm/second. Measure the force (N) during the test and record the maximum force (N).
5. The hardness of the detergent granules can be quantified by the force required to deform the granules to ⅕ of its initial height after soaking in water for 20 seconds. The results are shown in FIG. 4.

### EXAMPLE

### Example 1

### Preparation of Detergent Granules

25-35 wt % of normal light carbonate (D₅₀ of 100-150 μm) and 35-45 wt % ground light carbonate (D₅₀ of 15-30 μm) having a moisture content of less than 1 wt % (Industrias del Alcali) are mixed with 55 wt % active CMC (Amtex) in a batch/paddle mixer (ChemTech, Hangzhou, China) or physical agitated mixer/agglomerator (e.g., Lodige CB/KM mixer). Optionally, 10-30 wt % of sulfate (HUNAN XINLI CHEMICAL CO LTD) is added to the mixture. The paddle mixer is operated at 30-40 rpm for about 3 minutes to about 6 minutes at a temperature of about 30° C. to neutralize the anionic surfactant acid precursor to produce LAS. After neutralization, then an optional dusting step whereby an extra amount (up to 5 wt %) of ground light carbonate is added into the agglomerates for 30 secs of post-mixing to improve fresh granule flowability. Optionally, the resulting agglomerated detergent granules may be dried in one or more cooling or drying steps. Suitable equipments include fluid bed driers and air lifts. The resulting agglomerated detergent granulates produced has a bulk density of 700-800 g/L. Table 1 below provides the compositional percentages of the agglomerated detergent granules produced.

Agglomerated detergent granules made by a process of the present invention may be used as a finished product or may be combined with other materials to form such a finished detergent compositions as exemplified in Example 3.

TABLE 1
Sample Agglomerated Detergent Granules Compositions

| Ingredients | Example 1 | Example 2 | Example 3 |
|---|---|---|---|
| CMC (55% active) | 2.53 | 5.06 | 2.53 |
| NaLAS | 26.13 | 26.13 | 21.00 |
| Na₂CO₃ | 66.92 | 61.92 | 39.50 |
| Sulfate | 0 | 0 | 33.13 |
| Moisture | 1.41 | 1.81 | 1.4 |
| Misc. | 1.1 | 1.1 | 2.44 |
| Total | 100.0% | 100.0% | 100.0% |

### Example 2

### Assessed Properties of the Detergent Granule and Raw Materials

a) Median Particle Size: The Median Particle Sizes of the carbonate salts are determined in accordance with the assay described in the Test Method section. In one example, the Median Particle Size of the normal light carbonate salt and the ground light carbonate salt are as follows:

TABLE 2
Mean Particle Sizes of the Carbonates

| Material | D₅₀ |
|---|---|
| Normal Light Carbonate Salt | 100-250 μm |
| Ground light Carbonate Salt | 10-30 μm |

In another example, the Median Particle Size of the detergent granules with the CMC is 320 μm.
b) Saturation Capacity: The Saturation Capacity of the ground dense carbonate is determined in accordance with the assay described in the Test Method section. In one example, the Saturation Capacity of the ground dense carbonate is from about 0.20 to about 0.33
c) Hardness: Detergent granules with and without CMC were assayed in the above method to determine their hardness. The results are shown in graphs in FIG. 4 and indicate that considerably less Granule Compaction Force is required to compress the detergent granule with CMC then without it.

### Example 3

### Preparation of Detergent Compositions Comprising Granules

Suitable granular detergent compositions designed for use in washing machines or hand washing processes. The compositions are made by combining the listed ingredients in the listed proportions (weight % of active material except where noted otherwise).

TABLE 3
Examples of Granular Detergent Products

| | Ex. 1 | Ex. 2 | Ex. 3 |
|---|---|---|---|
| Ingredients | wt % | wt % | wt % |
| LAS (Non-sulphated anionic | 10.0 | 15.0-16.0 | 7.0 |
| surfactant) | | | |
| Mixture of alkyl sulphate surfactants | 1.5 | 1.5-2 | 1.5 |
| Cationic surfactant | 0.0-1.0 | 0.0-1.5 | 0.0-1.0 |
| Non ionic surfactant | 0.0-1.0 | 0.0-1.5 | 0.0-1.0 |
| Zeolite | 0.0-3.0 | 6.0-10.0 | 0.0-3.0 |
| Polymeric dispersing or soil release | 1.0-3.0 | 1.0-4.0 | 1.0-3.0 |
| agents | | | |
| Bleach and bleach activator | 0.0-5.0 | 4.0-6.0 | 2-3.0 |
| Silicate | 7.0-9.0 | — | 5.0-6.0 |
| Carbonate | 10.0-30.0 | 25.0-35.0 | 15.0-30.0 |
| Sulfate | 30.0-70.0 | 30.0-35.0 | 40.0-70.0 |
| CMC (55% Active) | 0.0-2.5 | 0.0-2.5 | 0.0-2.5 |

| | |
|---|---|
| Deionized water | Balance to 100 wt % |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent granule comprising, by weight of the detergent granule:
a) from about 10 wt % to about 30 wt %, preferably from about 20 wt % to about 28 wt %, and more preferably from about 22 wt % to about 26 wt % of at least one anionic surfactant;
b) from about 1 wt % to about 10 wt %, preferably from about 2 wt % to about 8 wt %, and more preferably from about 2.5 wt % to about 6 wt % of a water-swellable component; and
c) from about 30 wt % to about 80 wt %, preferably from about 40 wt % to about 70 wt %, and more preferably from about 50 wt % to about 65 wt % neutralizing agent;
wherein the water-swellable component is a cellulosic material that rapidly swells up within 10 minutes, preferably within preferably within 5 minutes, more preferably within 2 minutes, even more preferably within 1 minute, and most preferably within 10 seconds, after contact with water, and wherein the ratio of the neutralizing agent to the water-swellable component is from about 5:1 to about 30:1, preferably from about 10:1 to about 20:1.

2. The detergent granule of claim 1, wherein the anionic surfactant is obtained by a dry neutralization and agglomeration process, whereby the dry neutralization involves neutralization of an acid precursor of an anionic surfactant with the neutralizing agent, and agglomeration involves mixing in a mixer.

3. The detergent granule of claim 1, wherein the cellulosic material is selected from the group consisting of carboxy methyl cellulose (CMC), cross-linked CMC, modified CMC and mixtures thereof.

4. The detergent granule of claim 1, wherein the dry neutralization and agglomeration process is substantially free of water, preferably by weight of the detergent granule between about 0 wt % and about 3 wt %, preferably between about 0% and about 1%, and more preferably between about 0% and about 0.5% of water.

5. The detergent granule of claim 1, wherein the neutralizing agent is a carbonate salt selected from the group consisting of a normal light carbonate salt, a ground light carbonate salt, and mixtures thereof having a ratio from about 1:4 to about 1:10 of normal light carbonate salt to ground light carbonate salt, wherein the carbonate salts having a Median Particle Size (D₅₀) of:
a) between about 50 μm and about 250 μm for the normal light carbonate salt; and
b) between about 10 μm and about 30 μm for the ground light carbonate salt;
wherein D₅₀ is determined by the Median Particle Size Test Method.

6. The detergent granule of claim 5, wherein the carbonate salt is selected from the group consisting of sodium carbonate, sodium bicarbonate and mixtures thereof, preferably sodium carbonate.

7. The detergent granule of claim 4, further comprising from about 1 wt % to about 40 wt %, preferably from about 5 wt % to about 35 wt %, and more preferably from about 10 wt % to about 30 wt % sulfate, and wherein the ratio of the ground light carbonate salt to the sulfate is from about 1:0.5 to about 1:2.

8. The detergent granule of claim 1, wherein the neutralizing agent is a ground dense carbonate salt having a Saturation Capacity from about 0.20 to about 0.33 as determined by the Saturation Capacity Test Method.

9. The detergent granule of claim 1, wherein the granule having a Granule Compaction Force of from about 0.01 N to about 0.4 N, preferably from about 0.1 N to about 0.3 N, and more preferably from about 0.15 N to about 0.25 N, as determined by the Hardness Test Method.

10. The detergent granule of claim 1, wherein the granule is substantially moisture free.

11. The detergent granule of claim 1, wherein the detergent granule is in the form of an agglomerate having a Median Particle Size between about 100 μm and about 600 μm, preferably between about 200 μm and about 500 μm, and more preferably between about 300 μm and about 400 μm, as determined by the Median Particle Size Test Method.

12. A granular detergent composition comprising the detergent granules according to claim 1.

13. A process for making a detergent granule of claim 1, wherein the process comprises the steps of:
(a) mixing raw materials into a mixer, wherein the raw materials comprises of:
(i) from about 1 wt % to about 10 wt % of water-swellable component;
(ii) from about 10 wt % to about 30 wt % of an acid precursor of an anionic surfactant selected from the group consisting of alkylbenzene sulfonic acid, alkyl sulfuric acid, and mixtures thereof;
(iii) from about 30 wt % to about 70 wt % neutralizing agent;
(iv) from about 0 wt % to about 3 wt % water (including water in the other raw materials); and
(v) optionally from about 1 wt % to about 40 wt % of sulfate.
wherein the water-swellable component is a cellulosic material that rapidly swells up within 10 minutes, preferably within preferably within 5 minutes, more preferably within 2 minutes, even more preferably within 1 minute, and most preferably within 10 seconds, after contact with water, and wherein the ratio of the neutralizing agent to the water-swellable component is about 5:1 to about 30:1, preferably from about 10:1 to about 20:1;
(b) dry-neutralizing the acid precursor of the anionic surfactant with the neutralizing agent to produce an anionic surfactant; and
(c) agglomerating the raw materials from steps (a) and (b) to produce an agglomerate.

14. The process according to claim 13, wherein the pH of the mixture is at least 7.0 or greater, preferably 8.0 or greater, and more preferably 9.0 or greater.

15. The process according to claim 14, where the process is continuous, semi-continuous or batch process.

16. A granular detergent composition made from the process of claim 13.

17. A method of laundering clothes using the granular detergent composition of claim 12.

18. A method of reducing abrasiveness or grittiness hand feel of a granular detergent composition for hand-washing fabrics comprising the steps of adding a granular detergent composition of claim 12 in a wash liquor and hand-washing the fabrics in the wash liquor.
